(19) United States
(12) Patent Application Publication
(10) Pub. No.: US 2015/0150140 A1
(43) Pub. Date: May 28, 2015

(54) METHOD AND APPARATUS FOR DETERMINING SHAPES FOR DEVICES BASED ON PRIVACY POLICY

(71) Applicant: Nokia Corporation, Espoo (FI)

(72) Inventors: Debmalya BISWAS, Lausanne (CH); Julian NOLAN, Pully (CH); Matthew John LAWRENSON, Espoo (FI)

(73) Assignee: Nokia Corporation, Espoo (FI)

(21) Appl. No.: 14/090,545

(22) Filed: Nov. 26, 2013

(51) Int. Cl. G06F 21/60

(52) U.S. Cl. CPC G06F 21/60
USPC 726/26

(57) ABSTRACT

An approach is provided for determining at least one interaction mode of at least one application executing on at least one device, wherein the at least one device supports shifting from among a plurality of physical form factors. The approach also involves determining at least one selected physical form factor from among the plurality of physical form factors based, at least in part, on the at least one interaction mode, at least one user privacy policy, or a combination thereof. The approach further involves causing, at least in part, a shape shifting of the at least one device to the at least one selected physical form factor.

### BACKGROUND

With the advancement in sensors and actuator technologies the design for mobile devices have expanded from the static flat display surfaces to screens that physically transform themselves while taking user input, during data processing and at the time of displaying the output, to better represent the on-screen content. Needless to mention, there may be privacy implications if the device changes to a wrong shape and wrong viewing angle, thereby making confidential content visible to the nearby users. As a result, there is a need to control device shapes depending on the content being displayed, the user task being performed, and their corresponding sensitivity levels.

### SOME EXAMPLE EMBODIMENTS

Therefore, there is a need for an approach for causing a selection of at least one suitable shape for at least one device from one or more supported physical form factors, wherein the physical form factors conforms to the user privacy policy.

According to one embodiment, a method comprises determining at least one interaction mode of at least one application executing on at least one device, wherein the at least one device supports shifting from among a plurality of physical form factors. The method also comprises determining at least one selected physical form factor from among the plurality of physical form factors based, at least in part, on the at least one interaction mode, at least one user privacy policy, or a combination thereof. The method further comprises causing, at least in part, a shape shifting of the at least one device to the at least one selected physical form factor.

According to another embodiment, an apparatus comprises at least one processor, and at least one memory including computer program code for one or more computer programs, the at least one memory and the computer program code configured to, with the at least one processor, cause, at least in part, the apparatus to determine at least one interaction mode of at least one application executing on at least one device, wherein the at least one device supports shifting from among a plurality of physical form factors. The apparatus is also caused to determine at least one selected physical form factor from among the plurality of physical form factors based, at least in part, on the at least one interaction mode, at least one user privacy policy, or a combination thereof. The apparatus is further caused to cause, at least in part, a shape shifting of the at least one device to the at least one selected physical form factor.

According to another embodiment, a computer-readable storage medium carries one or more sequences of one or more instructions which, when executed by one or more processors, cause, at least in part, an apparatus to determine at least one interaction mode of at least one application executing on at least one device, wherein the at least one device supports shifting from among a plurality of physical form factors. The apparatus is also caused to determine at least one selected physical form factor from among the plurality of physical form factors based, at least in part, on the at least one interaction mode, at least one user privacy policy, or a combination thereof. The apparatus is further caused to cause, at least in part, a shape shifting of the at least one device to the at least one selected physical form factor.

According to another embodiment, an apparatus comprises means for determining at least one interaction mode of at least one application executing on at least one device, wherein the at least one device supports shifting from among a plurality of physical form factors. The apparatus also comprises means for determining at least one selected physical form factor from among the plurality of physical form factors based, at least in part, on the at least one interaction mode, at least one user privacy policy, or a combination thereof. The apparatus further comprises means for causing, at least in part, a shape shifting of the at least one device to the at least one selected physical form factor.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of selecting and/or recommending different device form factors depending on the privacy policy corresponding to the task to be performed, the content to be processed, the content to be displayed, the user privacy settings, the contextual information, the device capability or a combination thereof, according to one embodiment;

FIG. 2 is a diagram of the components of the configuration platform 109, according to one embodiment;

FIG. 3 is a flowchart of a process for causing a shape shifting of at least one device from one or more supported physical form factors, wherein the physical form factors conforms to the user privacy policy, according to one embodiment;

FIG. 4 is a flowchart of a process for determining at least one selected physical form factor based, at least in part, on the privacy sensitivity information, the contextual information, the privacy impact information, or a combination thereof, according to one embodiment;

FIG. 5 is a flowchart of a process for causing, at least in part, an application of one or more conflict resolution strategies upon determination that there is conflict in the at least one selected physical form factor, wherein the at least one selected physical form factor is determined from among the one or more recommended physical form factors, according to one embodiment;

FIG. 6 is a flowchart of a process for receiving a user input for specifying the at least one selected physical form factor and determining one or more available physical form factors for the at least one application based, at least in part, on the at least one user privacy policy, according to one embodiment;

FIG. 7 is a flowchart of a process for causing, at least in part, an application of the at least one physical form factor at the at least one device based, at least in part, on the data entry interaction for a duration of the data entry interaction, according to one embodiment;

FIG. 8 is a diagram of a user interface utilized in the process of selecting one or more shapes based, at least in part, on device capability information, according to one example embodiment;

FIG. 9 is a diagram of a user interface utilized in the process of determining privacy policy based on the attributes of the form factors of the at least one device, according to one example embodiment;

FIG. 10 is a diagram of a user interface utilized in the process of adapting the shape of a device consistent with the privacy policy for password input, according to one example embodiment;

FIG. 11 is a diagram of a user interface utilized in the process of determining one or more privacy preserving shapes for one or more data types based, at least in part, on the context of the at least one device, according to one example embodiment;

FIG. 12 is a diagram of a user interface utilized in the process of determining one or more privacy preserving shapes based, at least in part, on fine grained form factor attributes, according to one example embodiment;

FIG. 13 is a diagram of a user interface utilized in the process of determining at least one suitable shape based on sensitiveness of the data being displayed, according to one example embodiment;

FIG. 14 is a diagram of a user interface utilized in the process of determining conflict resolution strategies between multiple applications executing on at least one device, according to one example embodiment;

FIG. 15 is a diagram of hardware that can be used to implement an embodiment of the invention;

FIG. 16 is a diagram of a chip set that can be used to implement an embodiment of the invention; and

FIG. 17 is a diagram of a mobile terminal (e.g., handset) that can be used to implement an embodiment of the invention.

### DESCRIPTION OF SOME EMBODIMENTS

Examples of a method, apparatus, and computer program for causing a selection of at least one suitable shape for at least one device from one or more supported physical form factors, wherein the physical form factors conforms to the user privacy policy are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

With the recent development in flexible displays, the display for mobile devices is no longer restricted to flat and rigid form factors. Such development in the flexible display technologies have led to the innovation of shape shifting devices, wherein mobile devices may modify their shapes, thereby affecting the viewing angles for one or more users. On the other hand, there may be privacy implications with respect to the manner in which one or more content is being displayed on such shape shifting devices. A wrong shape and/or viewing angle can have the unintended effect of making a confidential content visible to nearby users. Therefore, there is a need to control the device shape depending on the content being displayed, the user task being performed, and their corresponding sensitivity levels. Needless to mention, a method of selecting device form factors based on user privacy policy while interacting with an application can provide protection against privacy intrusions. For instance, the device can curl inwards while displaying sensitive content to provide privacy protection against onlookers.

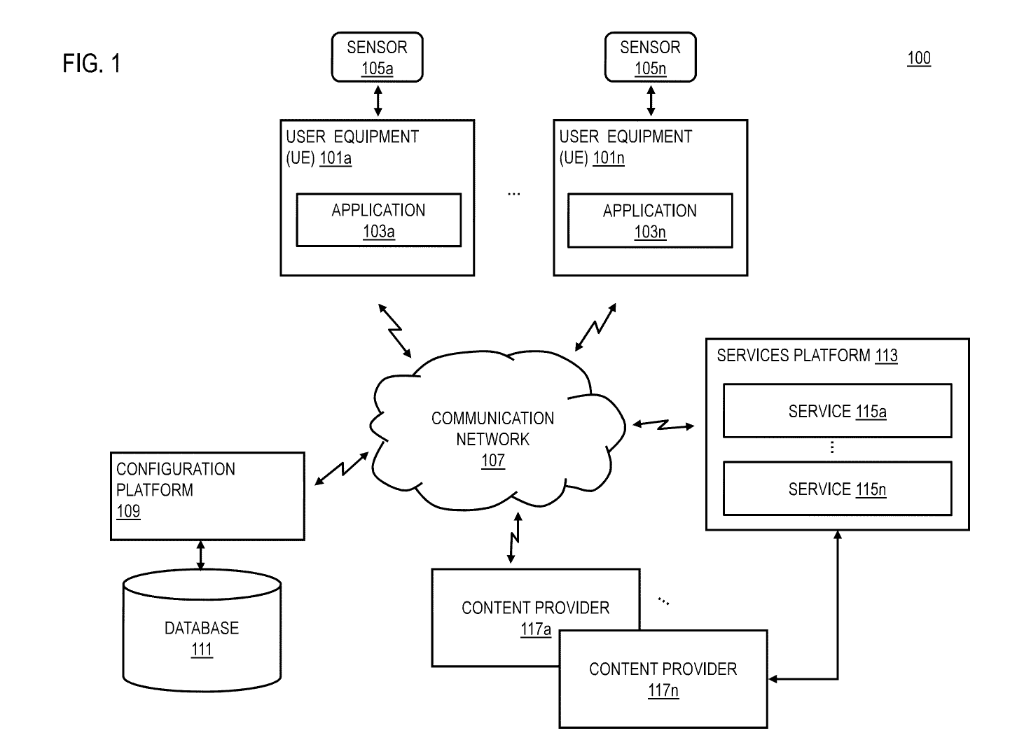

To address this problem, a system 100 of FIG. 1 introduces the capability to select and/or recommend different device form factors depending on the privacy policy corresponding to the task to be performed, the content to be processed, the content to be displayed, the user privacy settings, the contextual information, the device capability or a combination thereof. As shown in FIG. 1, the system 100 comprises user equipment (UEs) 101a-101n (collectively referred to as UE 101) that may include or be associated with applications 103a-103n (collectively referred to as applications 103) and sensors 105a-105n (collectively referred to as sensors 105). In one embodiment, the UEs 101 have connectivity to a configuration platform 109 via the communication network 107. In one embodiment, the configuration platform 109 performs one or more functions associated with causing a selection of at least one suitable shape for at least one device from one or more supported physical form factors, wherein the physical form factors conforms to the user privacy policy.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as, media applications (e.g., music and/or video streaming, photo exchange, etc.), social networking applications, content provisioning services, location-based services (e.g., providing proximity information), an internet browser, and the like. In one embodiment, one of the applications 103 at the UE 101 may act as a client for the configuration platform 109 and perform one or more functions associated with the functions of the configuration platform 109.

By way of example, the sensors 105 may be any type of sensor. In certain embodiments, the sensors 105 may include, for example, a global positioning sensor for gathering location data, a network detection sensor for detecting wireless signals or network data, a camera/imaging sensor for gathering image data, and the like. In one scenario, the sensors 105 may include location sensors (e.g., GPS), light sensors, tilt sensors, pressure sensors, audio sensors (e.g., microphone), or receivers for different short-range communications (e.g., Bluetooth, WiFi, etc.). In one embodiment, the sensors 105 may detect user interaction with a user interface generated by the UE 101, applications 103, and/or the configuration platform 109. In another embodiment, the one or more sensors 105 may provide the configuration platform 109 with information on the presence of other users nearby the at least one UE 101. In a further embodiment, the sensors 105 may determine the current device context (Ci) for the at least one UE 101 in terms of nearby people and sensors that is detected, and may record the detected contextual information. The sensors 105 may provide the configuration platform 109 with the detected and recorded contextual information for further processing.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the configuration platform 109 may be a platform with multiple interconnected components. The configuration platform 109 may include multiple servers, intelligent networking devices, computing devices, components and corresponding software for causing a shape shifting of the at least one device to the at least one selected physical form factor from among the plurality of physical form factors based, at least in part, on the at least one interaction mode and/or at least one user privacy policy.

In one embodiment, the configuration platform 109 may process and/or facilitate a processing of one or more data to determine their sensitivity levels. The configuration platform 109 may determine the privacy policy that conforms to the sensitivity levels of one or more data, thereby determining one or more privacy preserving shapes. Subsequently, the configuration platform 109 may cause a selection of at least one suitable shape based, at least in part, on the privacy threshold specified by the privacy policy. In another embodiment, the configuration platform 109 may determine at least one shape from among a plurality of physical form factors based, at least in part, on the user privacy settings, the user sensitivity levels settings, or a combination thereof. In a further embodiment, the configuration platform 109 may cause a shape shifting of the at least one UE 101 to the at least one selected physical form factor based, at least in part, on user interaction.

In one embodiment, the configuration platform 109 may restrict the one or more forms for at least one UE 101 based on user specified policies. The configuration platform 109 may cause a mapping of different user data, the one or more operations performed on the data and the sensitiveness of the data to the at least one user. The configuration platform 109 may further quantify the privacy impact for one or more data upon release. In one scenario, the configuration platform 109 may create an algorithm to generate the privacy preserving form factor profile that outlines the different form factors the at least one application executing on at least one shape shifting device from among a plurality of physical form factors can take at different stages of its execution.

M=f(user data,operation performed,sensitivity level)

In one embodiment, the configuration platform 109 may characterize transition between states by the following:

(a) User data involved (D);

(b) Input interaction mode (E.g. touch, voice, etc.) (I);

(c) Operation performed (P) and (I); or

(d) Output display mode (O).

Formally, the transition between execution states s₁ and s₂ may be denoted as follows:

tᵢ(sᵢ,sₖ):=f(Dᵢ,Iᵢ,Oᵢ,Pᵢ)

In one scenario, F={f1, f2, . . . } may denote the set of form factors supported by the at least one device. Each form factor may be characterized by certain fixed and variable parameters. In one example embodiment, the device shape in terms of a curved display might be fixed with run-time flexibility allowed in terms of the curve angle. In one scenario, each supported form factor f in the representative set F consists of fixed attributes only, such that a curved display with five possible curve angles is represented with five identifiers {f1, f2, f3, f4, f5} in F. Each form factor f is suited for certain input/output interaction modes. For instance, the device shaped as a small circular display to function as an alarm clock is not ideal for receiving large text inputs. As a result, the first step comprises of selecting the subset Fᵢ (subset of) F of form factors capable of supporting the transition characteristics (Dᵢ, Iᵢ, Oᵢ, Pᵢ). In one scenario, for each form factor fₓ in Fᵢ, the corresponding privacy impact (PIₓ) is computed by first factoring in the corresponding context (Cᵢ), for example, a crowded place with more nearby users or sensors may lead to a higher privacy impact. In another scenario, fine grained form factor attributes, for instance, the curve angle are also taken into account while computing the PI. This allows for an accommodating scenario where people in a crowded environment are positioned to the user's right while the device's curve angle ensures that the output is only visible on the left side. In a further scenario, even a form factor easily accessible to onlookers might be acceptable, as long as the user data processed by the transition (ti) is not sensitive for the user (e.g. public information). This is accommodated by factoring in the user sensitivity matrix M described earlier into the privacy impact computation;

PIₓ::=tᵢ×Cᵢ×Mᵢ

The final step consists of the configuration platform 109 allowing only those form factors fₓ in Fᵢ for a transition tᵢ, whose corresponding privacy impacts PIₓ fall within a privacy threshold specified by user defined privacy policies. Alternate embodiments include a scenario where an application executing on at least one shape shifting device specifies the form factor (or set of form factors) for a particular transition. Such feature may be accommodated by adding a form factor field (Fᵢ) to the functionality profile of the application.

tᵢ(sⱼ,sₖ):=f(Dᵢ,Iᵢ,Oᵢ,Pᵢ,Fᵢ)

The rest of the algorithm then proceeds as described earlier, with privacy impacts PI of the form factors in Fᵢ computed and compared to determine those permitted according to user specified privacy policies.

In one embodiment, the configuration platform 109 may include or have access to the database 111 to access or store any kind of data associated with one or more UE 101. In another embodiment, the configuration platform 109 may determine sensitivity level for one or more data, privacy policy for at least one user, etc., by comparing the one or more data with the one or more data stored in the database 111. The data stored in the database 111 may, for instance, be provided by the UE 101, the services platform 113, one or more services 115a-115n (or services 115), or one or more content providers 117a-117n (or content providers 117).

The services platform 113 may include any type of service. By way of example, the services platform 113 may include social networking services, content (e.g., audio, video, images, etc.) provisioning services, application services, storage services, contextual information determination services, location based services, information (e.g., weather, news, etc.) based services, etc. In one embodiment, the services platform 113 may interact with the UE 101, the configuration platform 109 and the content providers 117 to supplement or aid in the processing of the content information. In another embodiment, the services platform 113 may provide the configuration platform 109 with user preference information, contextual information, to determine at least one shape from among a plurality of physical form factors.

By way of example, services 115 may be an online service that reflects interests and/or activities of users. In one scenario, the services 115 provide representations of each user (e.g., a profile), his/her social links, and a variety of additional information. The services 115 allow users to share activities information, contextual information, and interests within their individual networks, and provides for data portability. The services 115 may additionally assist in providing the configuration platform 109 in determining sensitivity levels for one or more contents. In one embodiment, the services 115 may further assist the configuration platform 109 in profile mapping to protect the privacy interest of the one or more users of the UE 101.

The content providers 117 may provide content to the UE 101, the configuration platform 109, and the services 115 of the services platform 113. The content provided may be any type of content, such as textual content, audio content, video content, image content, etc. In one embodiment, the content providers 117 may provide content that may supplement content of the applications 103, the sensors 105, or a combination thereof. By way of example, the content providers 117 may provide content that may aid the configuration platform 109 in determining suitable privacy preserving forms while displaying one or more contents. In one embodiment, the content providers 117 may also store content associated with the UE 101, the configuration platform 109, and the services 115 of the services platform 113. In another embodiment, the content providers 117 may manage access to a central repository of data, and offer a consistent, standard interface to user's data.

By way of example, the UE 101, the configuration platform 109, the services platform 113, and the content providers 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

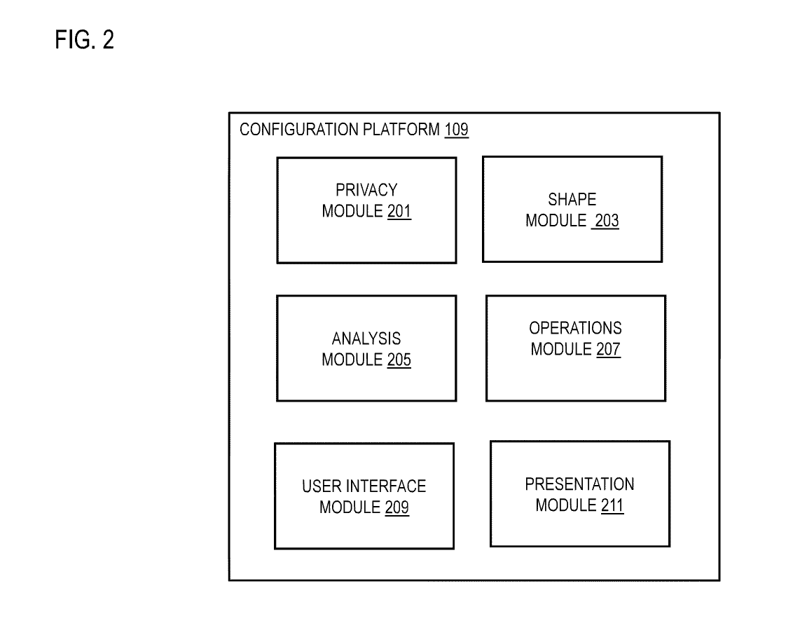

FIG. 2 is a diagram of the components of the configuration platform 109, according to one embodiment. By way of example, the configuration platform 109 includes one or more components for causing a selection of at least one suitable shape for at least one device from one or more supported physical form factors, wherein the physical form factors conforms to the user privacy policy, according to one embodiment. It is contemplated that the functions of these components may be combined in one or more components or performed by other components of equivalent functionality. In this embodiment, the configuration platform 109 includes a privacy module 201, a shape module 203, an analysis module 205, an operations module 207, a user interface module 209, and a presentation module 211.

In one embodiment, the privacy module 201 may determine privacy policy for at least one device based, at least in part, on sensitivity levels for one or more data, user privacy settings, data operations, data presentation, contextual information, or a combination thereof. In another embodiment, the privacy module 201 may cause, at least in part, a determination of one or more shapes for one or more data types based, at least in part, on fixed and variable parameters. The one or more fixed and variable parameters are based, at least in part, on privacy requirements for one or more user data involved. The privacy module 201 may determine the privacy requirement for one or more data being processed and/or the one or more data being displayed. In a further embodiment, the privacy module 201 may cause, at least in part, a selection of at least one suitable shape for at least one UE 101 based, at least in part, on the privacy threshold specified by the privacy policy. In one embodiment, the privacy module 201 may act as a recommendation engine proposing the most privacy preserving form factor for an application transition. This implies that the privacy module 201 may take a more proactive role, and rather than selecting shapes from among the specified form factors, it may independently determine and recommend the form that is most suitable for an application transition with minimal privacy impact.

In one embodiment, the shape module 203 may determine one or more privacy preserving shapes for one or more data based, at least in part, on the privacy policy. In another embodiment, the shape module 203 may cause, at least in part, a selection of at least one shape from among a plurality of physical form factors for displaying one or more data based, at least in part, on user interaction, wherein user interaction indicates a request to initiate a modification in shape for at least one device. In a further embodiment, the shape module 203 may cause a selection of at least one shape based, at least in part, on device orientation, device capability information, or a combination thereof. In one embodiment, the shape module 203 may cause a selection of a form based, at least in part, on one or more tasks being performed by at least one user.

In one embodiment, the analysis module 205 may cause a mapping of the privacy policy of at least one device and the contextual information associated with the device to determine at least one suitable form for data presentation. In another embodiment, the analysis module 205 may determine sensitivity levels for one or more data types. In one scenario, the analysis module 205 may determine the sensitivity levels for one or more data types based, at least in part, on the sensitiveness of the data to at least one user, the privacy impact for one or more data, or a combination thereof. In a further embodiment, the analysis module 205 may process and/or facilitate a processing of contextual information associated with at least one device to determine the presence of nearby users and may recommend the shape module 203 at least one shape based, at least in part, on the contextual information.

In one embodiment, the operations module 207 may cause a mapping of different data types associated with the at least one UE 101, the data operations performed and the sensitivity levels of the data for the at least one user. In another embodiment, the operations module 207 may quantify the sensitiveness of the one or more data to the user of the at least one UE 101, thereby controlling the privacy preserving device forms. In a further embodiment, the operations module 207 may determine the user data involved and/or the user interactions and/or the operation performed on the data involved and/or the output display mode to cause a restriction on one or more applications from performing certain actions.

In one embodiment, the user interface module 209 may generate user interface element in response to detection of an input for presentation of one or more data types. By way of example, the user interface module 209 may receive a user input for specifying the at least one selected physical form factor for presentation of one or more data types. Subsequently, the operations module 207 may apply user privacy policy at the at least one device based, at least in part, on the user input. In another embodiment, the user interface module 209 may determine at least one shape from among the plurality of physical form factors based, at least in part, on the at least one interaction mode, wherein the at least interaction mode includes, at least in part, a data entry interaction by a user. In a further embodiment, the user interface module 209 employs various application programming interfaces (APIs) or other function calls corresponding to the application 103 of UE 101, thus enabling the display of graphics primitives such as menus, buttons, data entry fields, etc., for generating the user interface elements.

In one embodiment, the presentation module 211 may cause a presentation of one or more data set in the most suitable shape from among a plurality of physical form factors based, at least in part, on user interaction, privacy policy, or a combination thereof. In another embodiment, the presentation module 211 may generate one or more presentations in various shapes for different data types based on their sensitivity levels. In a further embodiment, the presentation module 211 may work in conjunction with the privacy module 201, the shape module 203, the analysis module 205, the operations module 207, and the user interface module 209 to gather information on privacy policy, various shapes for the one or more data types, or a combination thereof.

The above presented modules and components of the configuration platform 109 can be implemented in hardware, firmware, software, or a combination thereof. Though depicted as a separate entity in FIG. 1, it is contemplated that the configuration platform 109 may be implemented for direct operation by respective UE 101. As such, the configuration platform 109 may generate direct signal inputs by way of the operating system of the UE 101 for interacting with the application 103. In another embodiment, one or more of the modules 201-211 may be implemented for operation by respective UEs, as a configuration platform 109, or combination thereof. Still further, the configuration platform 109 may be integrated for direct operation with the services 115, such as in the form of a widget or applet, in accordance with an information and/or subscriber sharing arrangement. The various executions presented herein contemplate any and all arrangements and models.

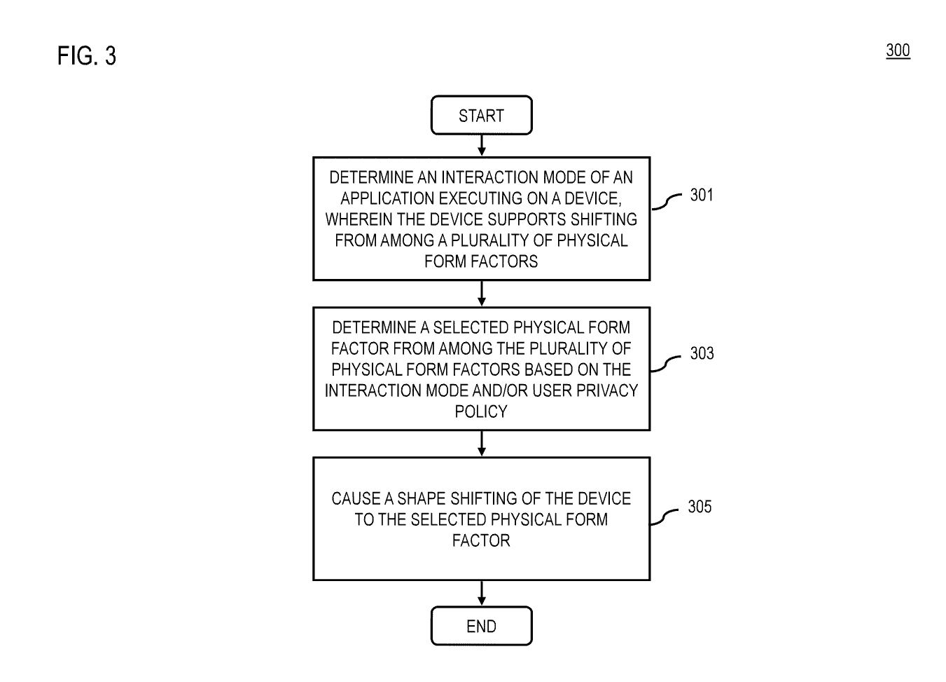

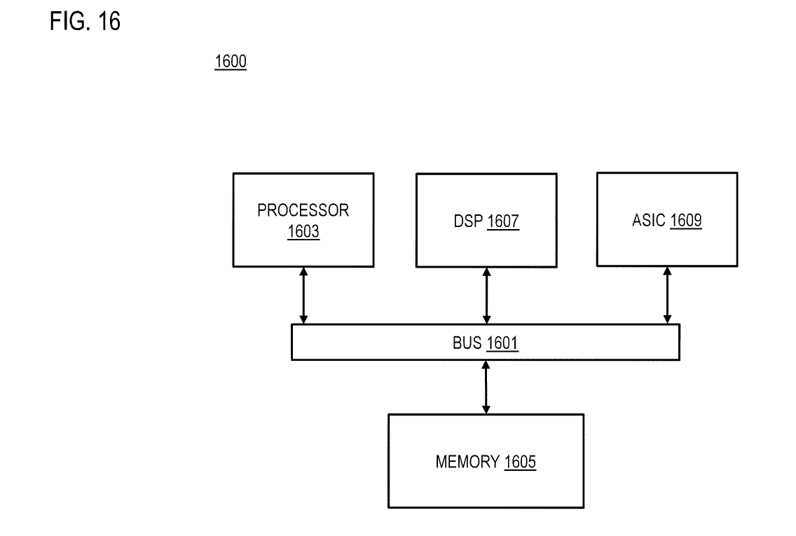

FIG. 3 is a flowchart of a process for causing a shape shifting of at least one device from one or more supported physical form factors, wherein the physical form factors conforms to the user privacy policy, according to one embodiment. In one embodiment, the configuration platform 109 performs the process 300 and is implemented in, for instance, a chip set including a processor and a memory as shown in FIG. 16.

In step 301, the configuration platform 109 determines at least one interaction mode of at least one application executing on at least one device, wherein the at least one device supports shifting from among a plurality of physical form factors. In one embodiment, the at least one interaction mode is associated with one or more specified physical form factors, and wherein the at least one selected physical form factor is selected from among the one or more specified physical form factors. In one example embodiment, the configuration platform 109 may cause, at least in part, a recommendation of one or more shapes for user interaction based, at least in part, on the mapping of privacy policy and the contextual information for at least one UE 101. In another example embodiment, the configuration platform 109 may cause a selection of at least one shape for displaying one or more data based, at least in part, on different user input interaction modes supported by the device. In one scenario, the configuration platform 109 may select different user input interaction modes, for instance, voice, images, videos etc. supported by the UE 101.

In step 303, the configuration platform 109 determines at least one selected physical form factor from among the plurality of physical form factors based, at least in part, on the at least one interaction mode, at least one user privacy policy, or a combination thereof. In one scenario, the optimal form factor is recommended from a user's privacy perspective, wherein the privacy and the context relationship with respect to selecting the interaction mode is considered.

In step 305, the configuration platform 109 causes, at least in part, a shape shifting of the at least one device to the at least one selected physical form factor.

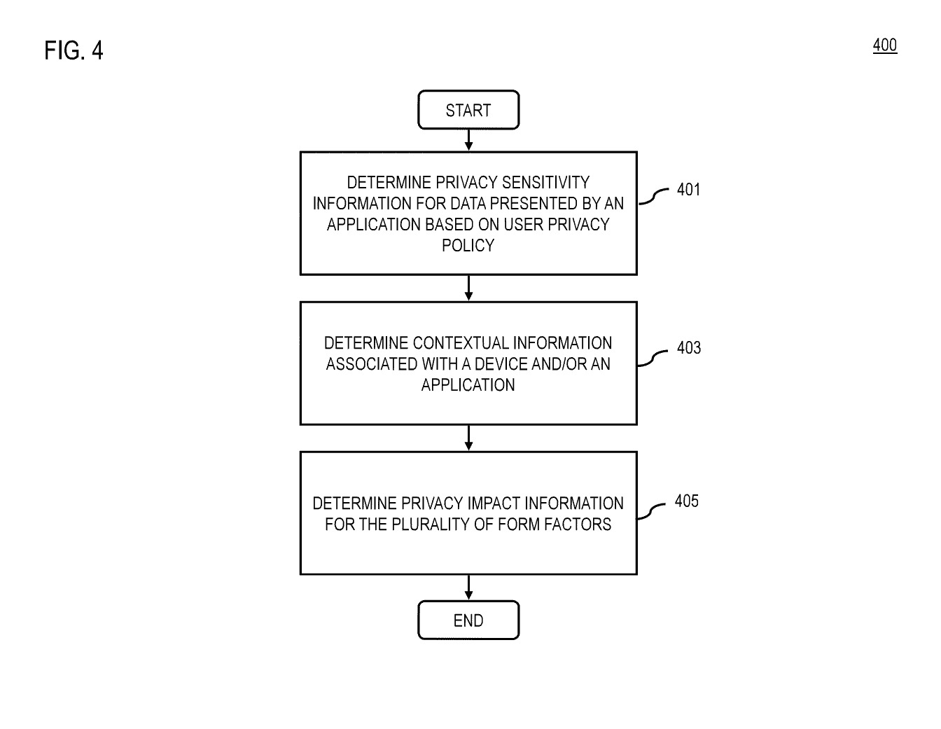

FIG. 4 is a flowchart of a process for determining at least one selected physical form factor based, at least in part, on the privacy sensitivity information, the contextual information, the privacy impact information, or a combination thereof, according to one embodiment. In one embodiment, the configuration platform 109 performs the process 400 and is implemented in, for instance, a chip set including a processor and a memory as shown in FIG. 16.

In step 401, the configuration platform 109 determines privacy sensitivity information for data presented by the at least one application based, at least in part, on the at least one user privacy policy, wherein the at least one selected physical form factor is further determined based, at least in part, on the privacy sensitivity information. In one example embodiment, the configuration platform 109 may process and/or facilitate a processing of one or more data to determine their sensitivity levels. The configuration platform 109 may determine sensitivity level based, at least in part, on the sensitiveness of the data to at least one user and/or the privacy impact of the one or more data. Subsequently, the configuration platform 109 may determine at least one shape for UE 101 based on the sensitivity level.

In step 403, the configuration platform 109 determines contextual information associated with the at least one device, the at least one application, or a combination thereof, wherein the at least one selected physical form factor is further determined based, at least on part, on the contextual information. In one scenario, the configuration platform 109 may process contextual information, for example, sensor information etc., associated with at least one UE 101 to determine the presence of nearby users and may cause selection of at least one shape based, at least in part, on the contextual information.

In step 405, the configuration platform 109 determines privacy impact information for the plurality of form factors, wherein the at least one selected physical form factor is further determined based, at least in part, on the privacy impact information. In one scenario, the configuration platform 109 may quantify the privacy impact for one or more data if released by mapping user data types, operations performed on them and their sensitiveness for the user. In another scenario, the corresponding privacy impact is computed by first factoring in the corresponding context, for instance, a crowded place with more nearby users may lead to a higher privacy impact.

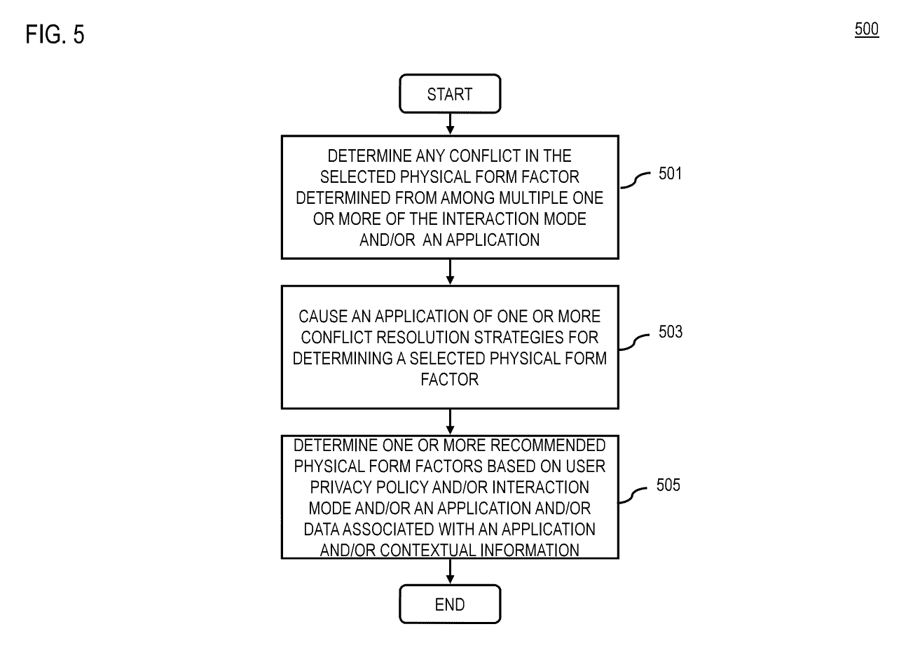

FIG. 5 is a flowchart of a process for causing, at least in part, an application of one or more conflict resolution strategies upon determination that there is conflict in the at least one selected physical form factor, wherein the at least one selected physical form factor is determined from among the one or more recommended physical form factors, according to one embodiment. In one embodiment, the configuration platform 109 performs the process 500 and is implemented in, for instance, a chip set including a processor and a memory as shown in FIG. 16.

In step 501, the configuration platform 109 determines that there is conflict in the at least one selected physical form factor determined from among multiple one or more of the at least one interaction mode, the at least one application, or a combination thereof. In one scenario, multiple applications may be running in parallel in a UE 101 that supports shifting from among a plurality of physical form factors. The multiple applications may specify their preferred form factors for their respective transitions, and since the UE 101 needs to change the form frequently it may results in conflict between the form factors specified by the one or more applications.

In step 503, the configuration platform 109 causes, at least in part, an application of one or more conflict resolution strategies for determining the at least one selected physical form factors. In one example embodiment, the configuration platform 109 may process user preference information, for example, priorities assigned to the one or more applications or the context based scheduling of the applications, as a conflict resolution mechanisms.

In step 505, the configuration platform 109 determines one or more recommended physical form factors based, at least in part, on the at least one user privacy policy, the at least one interaction mode, the at least one application, data associated with the at least one application, contextual information, or a combination thereof. In one embodiment, the at least one selected physical form factor is determined from among the one or more recommended physical form factors.

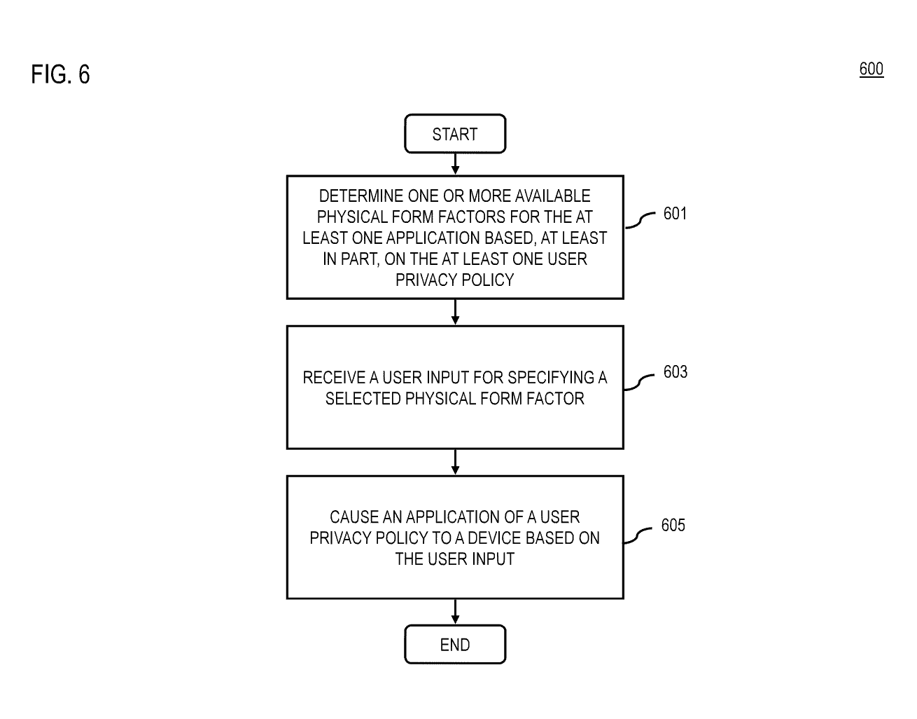

FIG. 6 is a flowchart of a process for receiving a user input for specifying the at least one selected physical form factor and determining one or more available physical form factors for the at least one application based, at least in part, on the at least one user privacy policy, according to one embodiment. In one embodiment, the configuration platform 109 performs the process 600 and is implemented in, for instance, a chip set including a processor and a memory as shown in FIG. 16.

In step 601, the configuration platform 109 determines one or more available physical form factors for the at least one application based, at least in part, on the at least one user privacy policy. In one scenario, the configuration platform 109 may determine privacy policy for at least one device based, at least in part, on sensitivity levels for one or more data, user privacy settings, data operations, data presentation, contextual information, or a combination thereof. In one example embodiment, the privacy policy may address a high level of sensitivity for confidential messages for at least one user, whereby the configuration platform 109 may determine the maximum privacy preserving shape from the one or more available physical form factors.

In step 603, the configuration platform 109 receives a user input for specifying the at least one selected physical form factor. In one scenario, the shape for at least one UE 101 for displaying one or more data may be based, at least in part, on user interaction. A user interaction indicates a request to initiate a modification in the shape for at least one UE 101 as per user preference.

In step 605, the configuration platform 109 causes, at least in part, an application of the at least one user privacy policy at the at least one device based, at least in part, on the user input. In one example embodiment, the configuration platform 109 may incorporate the user preference information in the user privacy policy, thereby the one or more shape determined for the at least one UE 101 may reflect the user preference during display of one or more data.

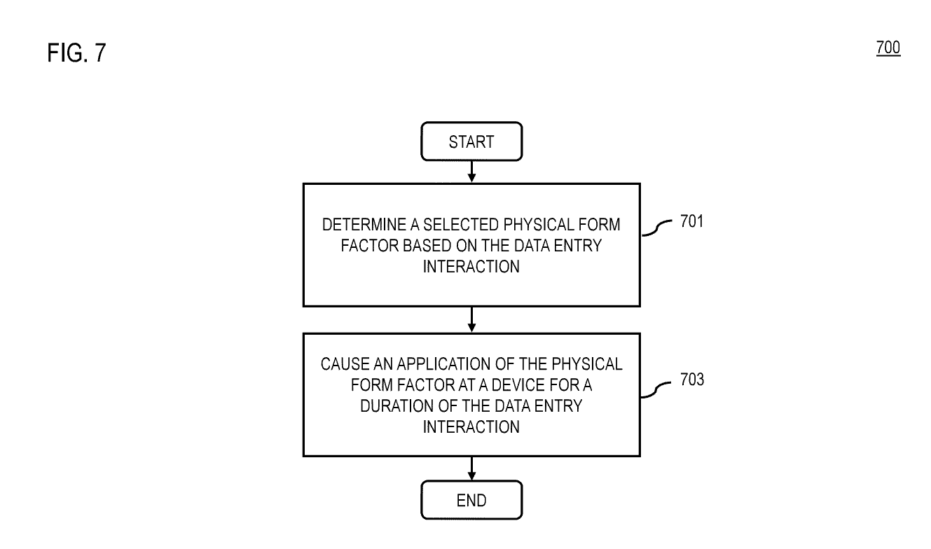

FIG. 7 is a flowchart of a process for causing, at least in part, an application of the at least one physical form factor at the at least one device based, at least in part, on the data entry interaction for a duration of the data entry interaction, according to one embodiment. In one embodiment, the configuration platform 109 performs the process 700 and is implemented in, for instance, a chip set including a processor and a memory as shown in FIG. 16.

In step 701, the configuration platform 109 determines at least one interaction mode wherein the at least interaction mode includes, at least in part, a data entry interaction by a user. The method further comprises determining the at least one selected physical form factor based, at least in part, on the data entry interaction. In one scenario, the configuration platform 109 may cause a UE 101 to adapt to a shape consistent with a password input, a UE 101 shaped as a small circular display to function as an alarm clock is not ideal for password entry. Accordingly, the UE 101 may adapt its form such that it curls inwards to better protect the password from being seen by nearby users.

In step 703, the configuration platform 109 causes, at least in part, an application of the at least one physical form factor at the at least one device for a duration of the data entry interaction. In one scenario, the configuration platform 109 may determine the sensitivity level for one or more task involved, for instance, a task involving password input for mobile banking may have a high sensitivity level. Subsequently, the configuration platform 109 may cause a UE 101 to curve to the left upon determination that one or more nearby users are located on the right of the UE 101, thereby ensuring that only the user can view the display. After the user enters the password, and the entire mobile banking transaction is complete, the UE 101 may return to its form prior to the password input.

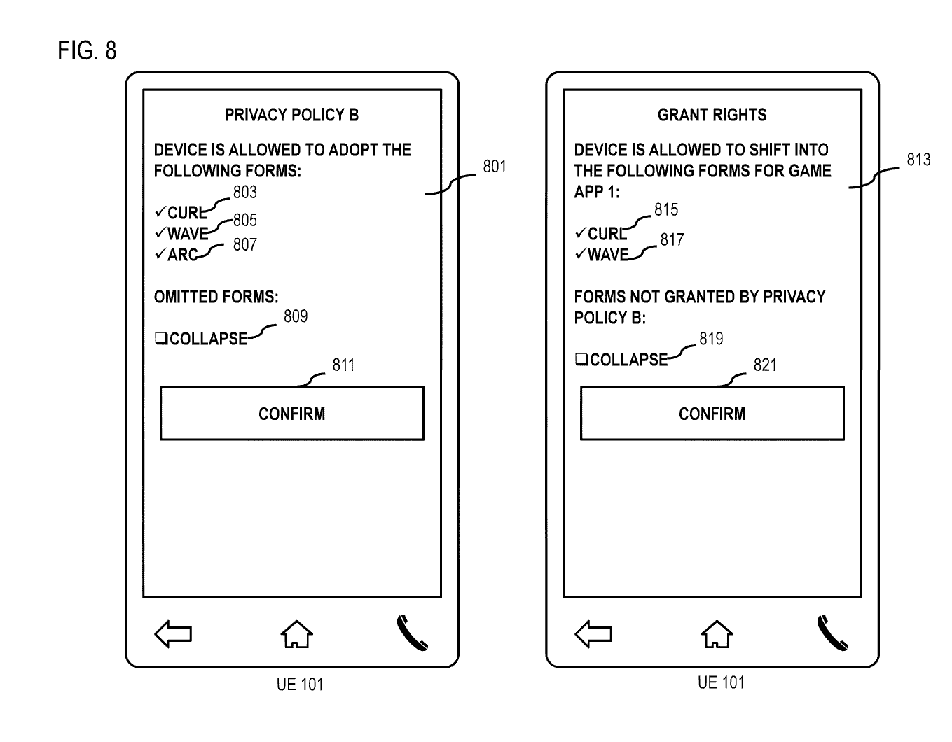

FIG. 8 is a diagram of a user interface utilized in the process of selecting one or more shapes based, at least in part, on device capability information, according to one example embodiment. In one scenario, user Z may set a privacy policy B [801] which establishes the range of shapes UE 101 may adopt, namely curl [803], wave [805] and arc [807]. In addition, user Z may be informed on the at least one shape not supported by the UE 101, for instance, collapse [809]. The user may enforce the privacy policy B by pressing confirm [811]. Subsequently, the configuration platform 109 may grant permission to the at least one shape that conforms to the privacy level described in policy B, wherein the shape of the device may be constrained by the attributes of the privacy policy B [813]. In one scenario, user Z may select at least one shape for UE 101 as per his/her preference and press confirm [821] to acquire permission by the configuration platform 109 for changing the shape of the UE 101. The configuration platform 109 may grant permission to either curl [815] or wave [817] the shape of the UE 101 but not collapse [819] because the shape does not conform to the privacy level described in policy B.

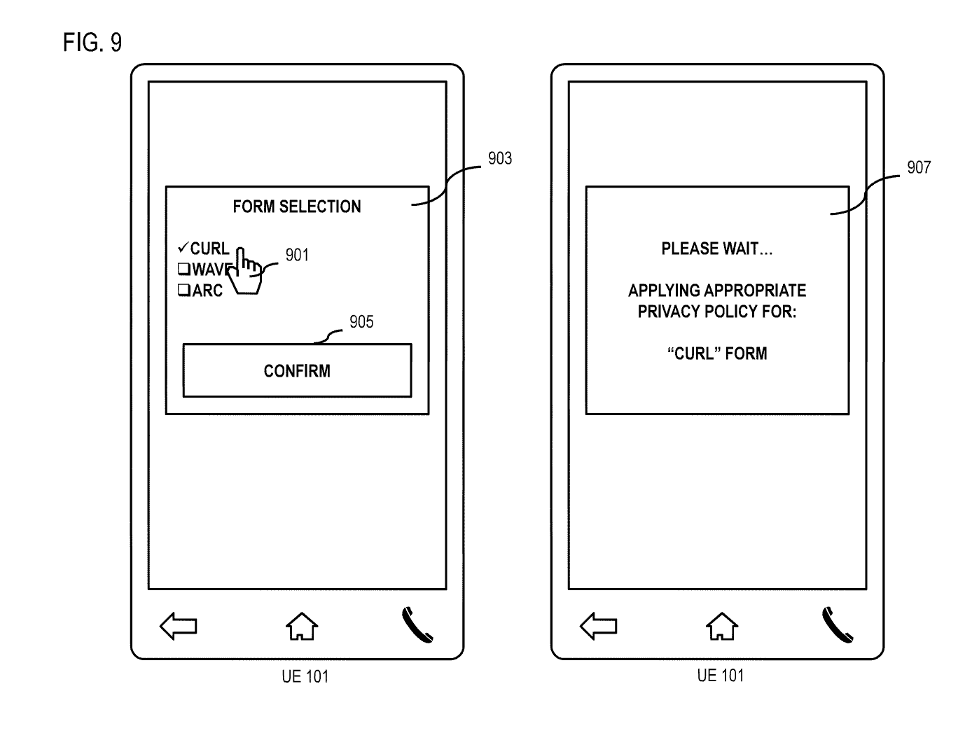

FIG. 9 is a diagram of a user interface utilized in the process of determining privacy policy based on the attributes of the form factors of the at least one device, according to one example embodiment. In one scenario, user X may select a shape for the at least one device as per his/her preference, for example, user X selects curl [901] from the form selection menu [903] and may endorse the selection by pressing confirm [905]. The form selection menu may list various shapes the UE 101 can adjust to. Consequently, the configuration platform 109 may use the attributes of the chosen form to select an appropriate privacy policy which may be applied by the device [907].

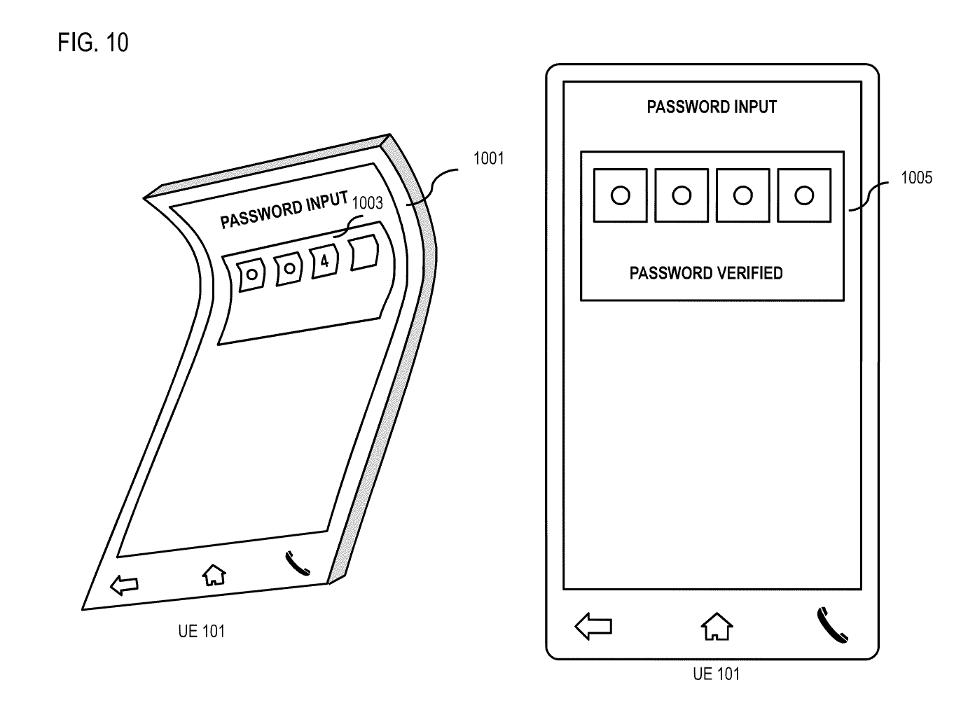

FIG. 10 is a diagram of a user interface utilized in the process of adapting the shape of a device consistent with the privacy policy for password input, according to one example embodiment. In one scenario, the configuration platform 109 may cause a UE 101 to adapt to a privacy preserving shape while taking a password input from at least one user [1001]. Accordingly, the UE 101 may curl inwards to better protect the password from being seen by other people in the vicinity [1001]. In addition, the configuration platform 109 may acknowledge easy viewing of the password for the user during adaptation of the UE 101 to a privacy preserving shape, thereby ensuring that the inward curling of the UE 101 does not restrict password view for the user [1003]. Subsequently, the UE 101 may return to its shape prior to the password input upon determination that the user has entered the password and the password has been verified [1005].

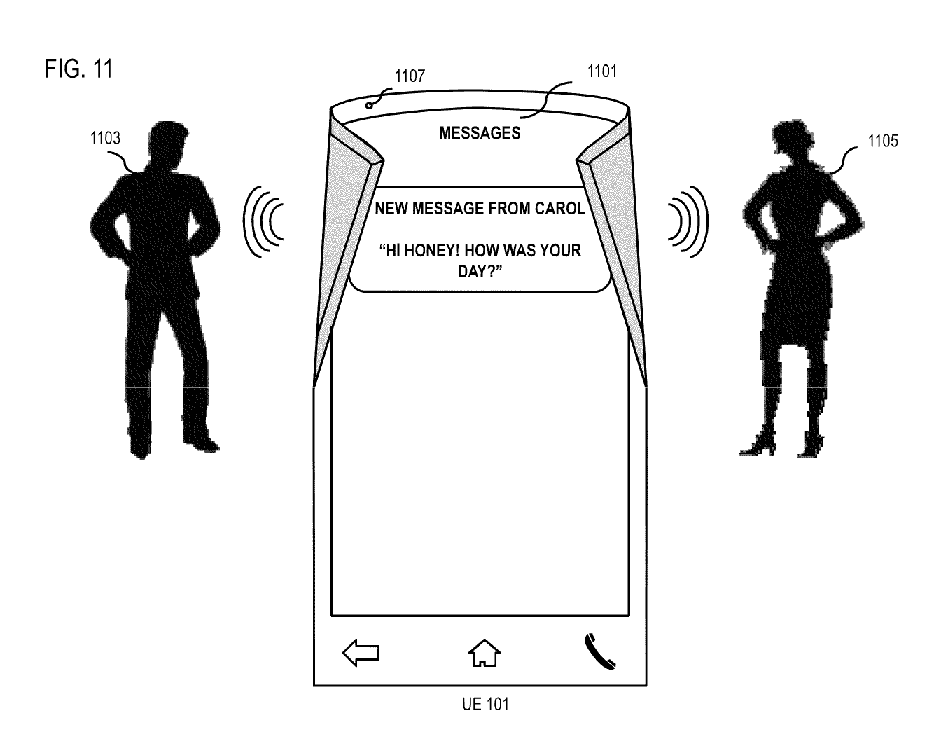

FIG. 11 is a diagram of a user interface utilized in the process of determining one or more privacy preserving shapes for one or more data types based, at least in part, on the context of the at least one device, according to one example embodiment. In one embodiment, the configuration platform 109 may process and/or facilitate a processing of contextual information associated with at least one device to determine the presence of nearby users. Then, the configuration platform 109 may cause, at least in part, a selection of at least one shape based, at least in part, on the contextual information. In one scenario, user Z is travelling in a bus and receives a personal message from his wife [1101], whereby the UE 101 may change its shape based, at least in part, on detection of nearby people [1103, 1105] detected via one or more sensors [1107] associated with the UE 101. Consequently, the UE 101 may curve its shape in a manner that only user Z can view the message.

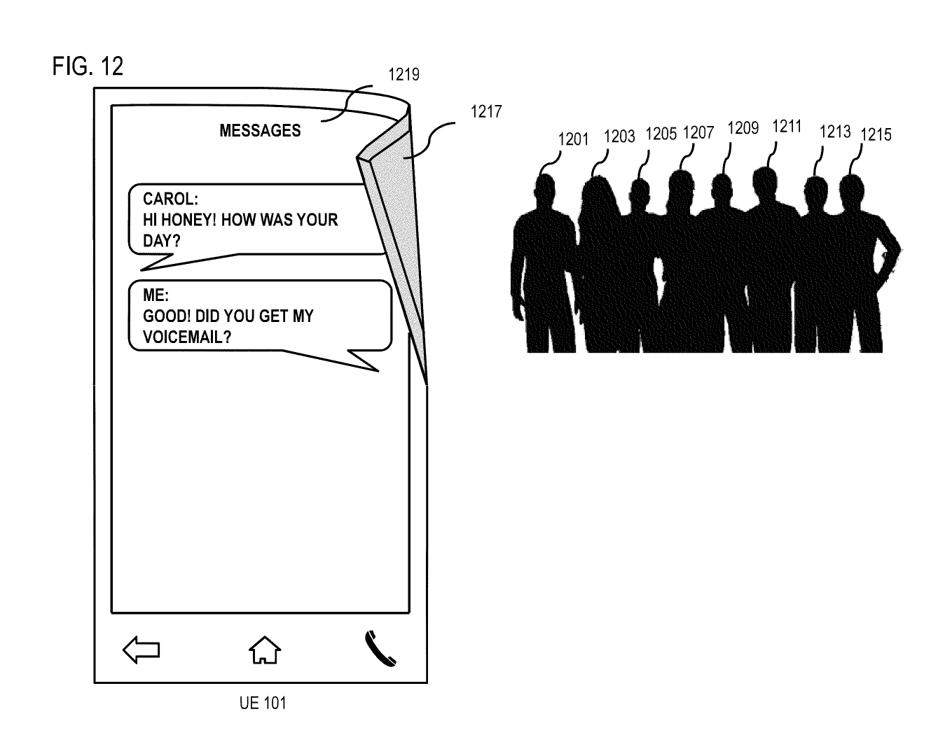

FIG. 12 is a diagram of a user interface utilized in the process of determining one or more privacy preserving shapes based, at least in part, on fine grained form factor attributes, according to one example embodiment. In one scenario, the configuration platform 109 may determine the position for one or more people around the at least one user via one or more sensors associated with the at least one UE 101. In a further scenario, the configuration platform 109 may determine the one or more people nearby are positioned to the right of the UE 101 [1201, 1203, 1205, 1207, 1209, 1211, 1213, 1215], whereby the configuration platform 109 may cause the UE 101 to have a curve angle on the right [1217], ensuring that the output is visible only on the left for the at least one user to view [1219].

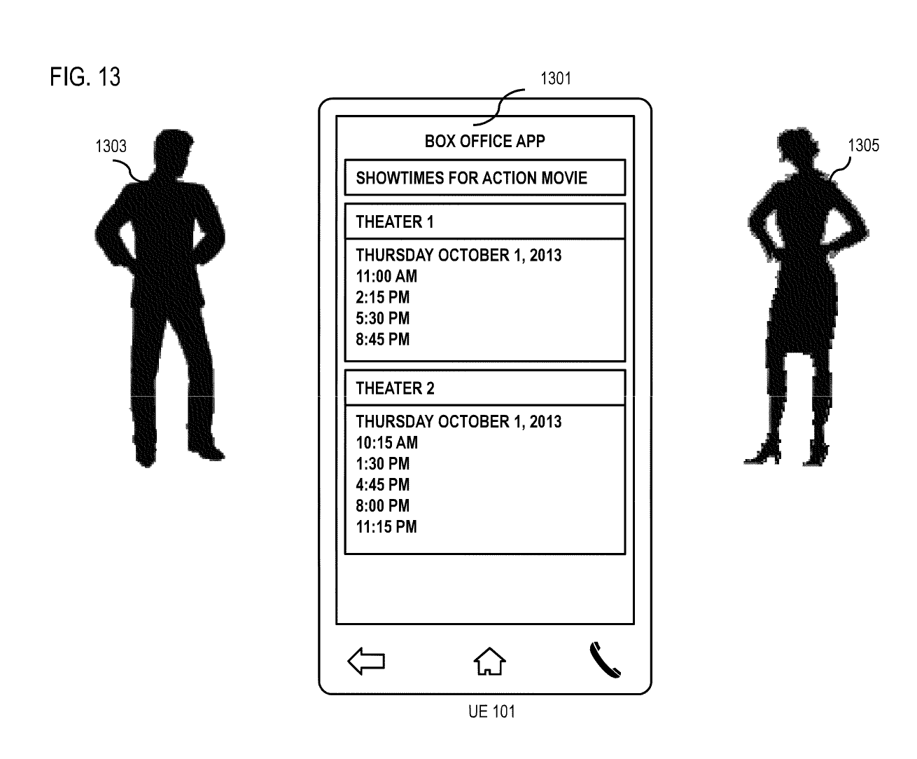

FIG. 13 is a diagram of a user interface utilized in the process of determining at least one suitable shape based on sensitiveness of the data being displayed, according to one example embodiment. In one scenario, the UE 101 may display a public message, for example, schedule for a movie [1301], in a manner that is convenient for a user irrelevant to the fact that the message can be seen by other people around the user [1303, 1305]. In another scenario, a shape format for a UE 101 though easily accessible by onlookers might be acceptable, as long as the data processed by the transition is not sensitive to the user.

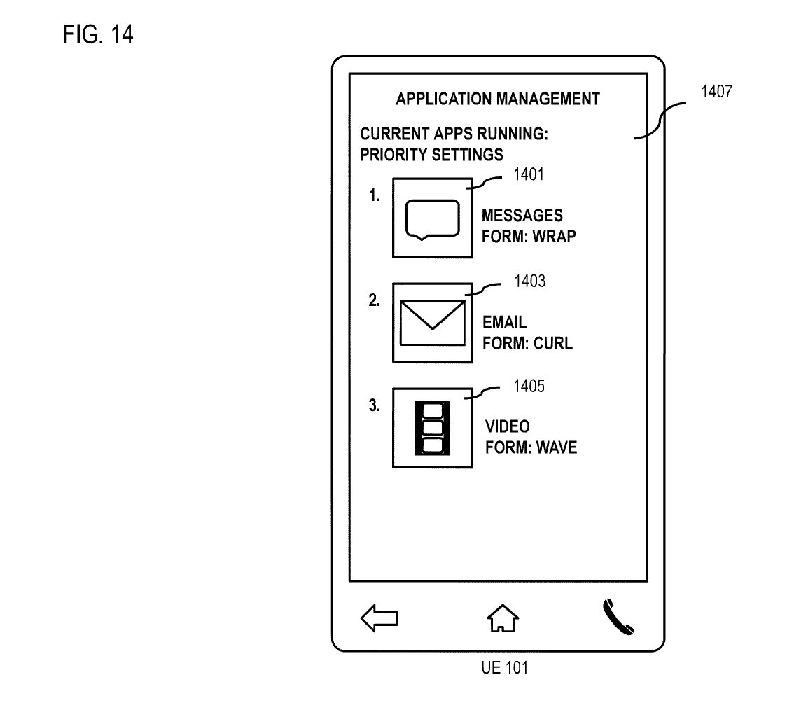

FIG. 14 is a diagram of a user interface utilized in the process of determining conflict resolution strategies between multiple applications executing on at least one device, according to one example embodiment. In one scenario, multiple applications [1401, 1403, 1405] may be running at the same time in the at least one UE 101 [1407], wherein the one or more applications may specify their preferred shapes for their respective transitions. Needless to mention, each application may have distinct preference on shapes hence leading to potential conflicts because there may exist a need to change the shapes frequently between the application specified form factors. In such situation, the configuration platform 109 may apply different conflict resolution strategies, for instance, priorities may be assigned to applications based on their scheduling.

The processes described herein for causing a selection of at least one suitable shape for at least one device from one or more supported physical form factors, wherein the physical form factors conforms to the user privacy policy may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

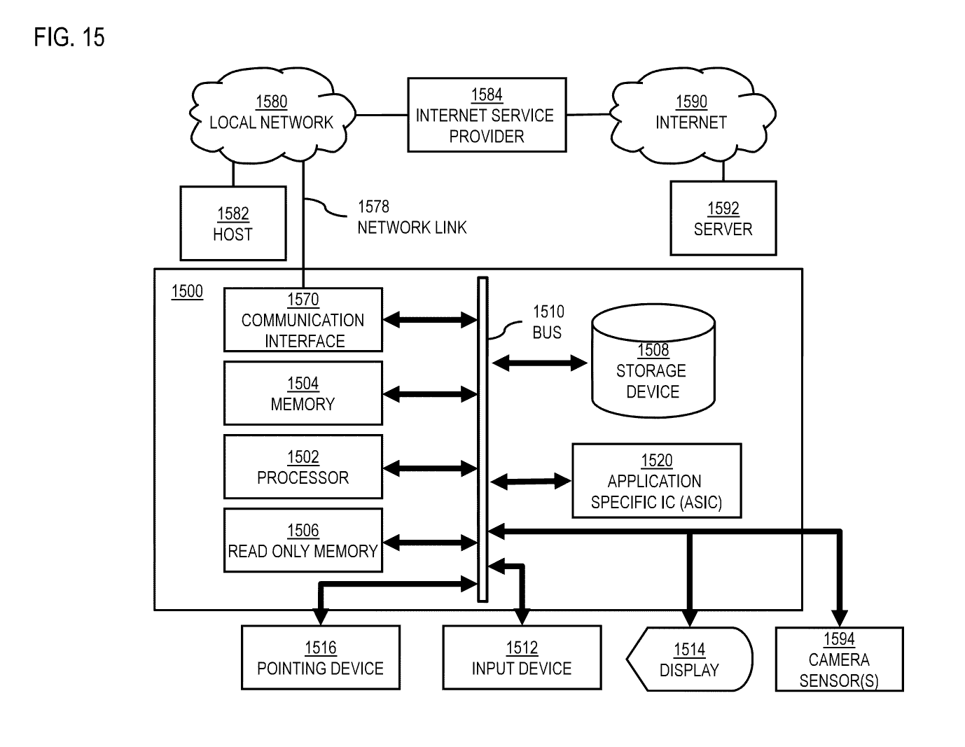

FIG. 15 illustrates a computer system 1500 upon which an embodiment of the invention may be implemented. Although computer system 1500 is depicted with respect to a particular device or equipment, it is contemplated that other devices or equipment (e.g., network elements, servers, etc.) within FIG. 15 can deploy the illustrated hardware and components of system 1500. Computer system 1500 is programmed (e.g., via computer program code or instructions) to cause a selection of at least one suitable shape for at least one device from one or more supported physical form factors, wherein the physical form factors conforms to the user privacy policy as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of causing a selection of at least one suitable shape for at least one device from one or more supported physical form factors, wherein the physical form factors conforms to the user privacy policy.

A bus 1510 includes one or more parallel conductors of information so that information is transferred quickly among devices coupled to the bus 1510. One or more processors 1502 for processing information are coupled with the bus 1510.

A processor (or multiple processors) 1502 performs a set of operations on information as specified by computer program code related to causing a selection of at least one suitable shape for at least one device from one or more supported physical form factors, wherein the physical form factors conforms to the user privacy policy. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1500 also includes a memory 1504 coupled to bus 1510. The memory 1504, such as a random access memory (RAM) or any other dynamic storage device, stores information including processor instructions for causing a selection of at least one suitable shape for at least one device from one or more supported physical form factors, wherein the physical form factors conforms to the user privacy policy. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or any other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for causing a selection of at least one suitable shape for at least one device from one or more supported physical form factors, wherein the physical form factors conforms to the user privacy policy, is provided to the bus 1510 for use by the processor from an external input device 1512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT), a liquid crystal display (LCD), a light emitting diode (LED) display, an organic LED (OLED) display, a plasma screen, or a printer for presenting text or images, and a pointing device 1516, such as a mouse, a trackball, cursor direction keys, or a motion sensor, for controlling a position of a small cursor image presented on the display 1514 and issuing commands associated with graphical elements presented on the display 1514, and one or more camera sensors 1594 for capturing, recording and causing to store one or more still and/or moving images (e.g., videos, movies, etc.) which also may comprise audio recordings. In some embodiments, for example, in embodiments in which the computer system 1500 performs all functions automatically without human input, one or more of external input device 1512, display device 1514 and pointing device 1516 may be omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of ASICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 107 for causing a selection of at least one suitable shape for at least one device from one or more supported physical form factors, wherein the physical form factors conforms to the user privacy policy to the UE 101.

The term “computer-readable medium” as used herein refers to any medium that participates in providing information to processor 1502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1508. Volatile media include, for example, dynamic memory 1504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1520.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system 1500 can be deployed in various configurations within other computer systems, e.g., host 1582 and server 1592.

At least some embodiments of the invention are related to the use of computer system 1500 for implementing some or all of the techniques described herein. According to one embodiment of the invention, those techniques are performed by computer system 1500 in response to processor 1502 executing one or more sequences of one or more processor instructions contained in memory 1504. Such instructions, also called computer instructions, software and program code, may be read into memory 1504 from another computer-readable medium such as storage device 1508 or network link 1578. Execution of the sequences of instructions contained in memory 1504 causes processor 1502 to perform one or more of the method steps described herein. In alternative embodiments, hardware, such as ASIC 1520, may be used in place of or in combination with software to implement the invention. Thus, embodiments of the invention are not limited to any specific combination of hardware and software, unless otherwise explicitly stated herein.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server host 1592 transmits program code for a particular application, requested by a message sent from computer 1500, through Internet 1590, ISP equipment 1584, local network 1580 and communications interface 1570. The received code may be executed by processor 1502 as it is received, or may be stored in memory 1504 or in storage device 1508 or any other non-volatile storage for later execution, or both. In this manner, computer system 1500 may obtain application program code in the form of signals on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set or chip 1600 upon which an embodiment of the invention may be implemented. Chip set 1600 is programmed to cause a selection of at least one suitable shape for at least one device from one or more supported physical form factors, wherein the physical form factors conforms to the user privacy policy as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1600 can be implemented in a single chip. It is further contemplated that in certain embodiments the chip set or chip 1600 can be implemented as a single “system on a chip.” It is further contemplated that in certain embodiments a separate ASIC would not be used, for example, and that all relevant functions as disclosed herein would be performed by a processor or processors. Chip set or chip 1600, or a portion thereof, constitutes a means for performing one or more steps of providing user interface navigation information associated with the availability of functions. Chip set or chip 1600, or a portion thereof, constitutes a means for performing one or more steps of causing a selection of at least one suitable shape for at least one device from one or more supported physical form factors, wherein the physical form factors conforms to the user privacy policy.

In one embodiment, the chip set or chip 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1600 includes merely one or more processors and some software and/or firmware supporting and/or relating to and/or for the one or more processors.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to cause a selection of at least one suitable shape for at least one device from one or more supported physical form factors, wherein the physical form factors conforms to the user privacy policy. The memory 1605 also stores the data associated with or generated by the execution of the inventive steps.

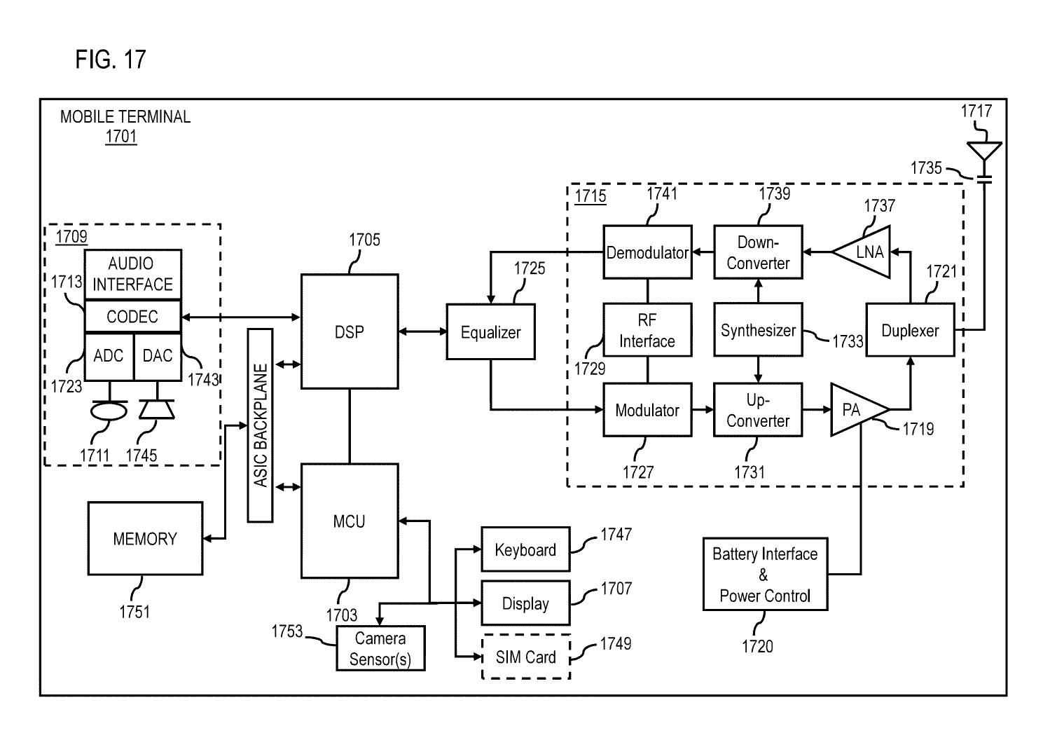

FIG. 17 is a diagram of exemplary components of a mobile terminal (e.g., handset) for communications, which is capable of operating in the system of FIG. 1, according to one embodiment. In some embodiments, mobile terminal 1701, or a portion thereof, constitutes a means for performing one or more steps of causing a selection of at least one suitable shape for at least one device from one or more supported physical form factors, wherein the physical form factors conforms to the user privacy policy. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps of causing a selection of at least one suitable shape for at least one device from one or more supported physical form factors, wherein the physical form factors conforms to the user privacy policy. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1725 for compensation of any frequency-dependent impairments that occur during transmission though the air such as phase and amplitude distortion. After equalizing the bit stream, the modulator 1727 combines the signal with a RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703 which can be implemented as a Central Processing Unit (CPU).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 to cause a selection of at least one suitable shape for at least one device from one or more supported physical form factors, wherein the physical form factors conforms to the user privacy policy. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

Further, one or more camera sensors 1753 may be incorporated onto the mobile station 1701 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of at least one interaction mode of at least one application executing on at least one device, wherein the at least one device supports shifting from among a plurality of physical form factors;
at least one determination of at least one selected physical form factor from among the plurality of physical form factors based, at least in part, on the at least one interaction mode, at least one user privacy policy, or a combination thereof; and
a shape shifting of the at least one device to the at least one selected physical form factor.

2. A method of claim 1, wherein the (1) data and/or (2) information and/or (3) at least one signal are further based, at least in part, on the following:
at least one determination of privacy sensitivity information for data presented by the at least one application based, at least in part, on the at least one user privacy policy,
wherein the at least one selected physical form factor is further determined based, at least in part, on the privacy sensitivity information.

3. A method of claim 1, wherein the (1) data and/or (2) information and/or (3) at least one signal are further based, at least in part, on the following:
at least one determination of contextual information associated with the at least one device, the at least one application, or a combination thereof,
wherein the at least one selected physical form factor is further determined based, at least on part, on the contextual information.

4. A method of claim 1, wherein the at least one interaction mode is associated with one or more specified physical form factors, and wherein the at least one selected physical form factor is selected from among the one or more specified physical form factors.

5. A method of claim 1, wherein the (1) data and/or (2) information and/or (3) at least one signal are further based, at least in part, on the following:
at least one determination of privacy impact information for the plurality of form factors,
wherein the at least one selected physical form factor is further determined based, at least in part, on the privacy impact information.

6. A method of claim 1, wherein the (1) data and/or (2) information and/or (3) at least one signal are further based, at least in part, on the following:
at least one determination that there is conflict in the at least one selected physical form factor determined from among multiple one or more of the at least one interaction mode, the at least one application, or a combination thereof; and
an application of one or more conflict resolution strategies for determining the at least one selected physical form factor.

7. A method of claim 1, wherein the (1) data and/or (2) information and/or (3) at least one signal are further based, at least in part, on the following:
at least one determination of one or more recommended physical form factors based, at least in part, on the at least one user privacy policy, the at least one interaction mode, the at least one application, data associated with the at least one application, contextual information, or a combination thereof,
wherein the at least one selected physical form factor is determined from among the one or more recommended physical form factors.

8. A method of claim 1, wherein the (1) data and/or (2) information and/or (3) at least one signal are further based, at least in part, on the following:
at least one determination of one or more available physical form factors for the at least one application based, at least in part, on the at least one user privacy policy.

9. A method of claim 1, wherein the (1) data and/or (2) information and/or (3) at least one signal are further based, at least in part, on the following:
a user input for specifying the at least one selected physical form factor; and
an application of the at least one user privacy policy at the at least one device based, at least in part, on the user input.

10. A method of claim 1, wherein the at least interaction mode includes, at least in part, a data entry interaction by a user, wherein the (1) data and/or (2) information and/or (3) at least one signal are further based, at least in part, on the following:
determining the at least one selected physical form factor based, at least in part, on the data entry interaction; and
causing, at least in part, an application of the at least one physical form factor at the at least one device for a duration of the data entry interaction.

11. An apparatus comprising:
at least one processor; and
at least one memory including computer program code for one or more programs,
the at least one memory and the computer program code configured to, with the at least one processor, cause the apparatus to perform at least the following,
determine at least one interaction mode of at least one application executing on at least one device, wherein the at least one device supports shifting from among a plurality of physical form factors;
determine at least one selected physical form factor from among the plurality of physical form factors based, at least in part, on the at least one interaction mode, at least one user privacy policy, or a combination thereof; and
cause, at least in part, a shape shifting of the at least one device to the at least one selected physical form factor.

12. An apparatus of claim 11, wherein the apparatus is further caused to:
determine privacy sensitivity information for data presented by the at least one application based, at least in part, on the at least one user privacy policy,
wherein the at least one selected physical form factor is further determined based, at least in part, on the privacy sensitivity information.

13. An apparatus of claim 11, wherein the apparatus is further caused to:
determine contextual information associated with the at least one device, the at least one application, or a combination thereof,
wherein the at least one selected physical form factor is further determined based, at least on part, on the contextual information.

14. An apparatus of claim 11, wherein the at least one interaction mode is associated with one or more specified physical form factors, and wherein the at least one selected physical form factor is selected from among the one or more specified physical form factors.

15. An apparatus of claim 11, wherein the apparatus is further caused to:
determine privacy impact information for the plurality of form factors,
wherein the at least one selected physical form factor is further determined based, at least in part, on the privacy impact information.

16. An apparatus of claim 11, wherein the apparatus is further caused to:
determine that there is conflict in the at least one selected physical form factor determined from among multiple one or more of the at least one interaction mode, the at least one application, or a combination thereof; and
cause, at least in part, an application of one or more conflict resolution strategies for determining the at least one selected physical form factor.

17. An apparatus of claim 11, wherein the apparatus is further caused to:
determine one or more recommended physical form factors based, at least in part, on the at least one user privacy policy, the at least one interaction mode, the at least one application, data associated with the at least one application, contextual information, or a combination thereof,
wherein the at least one selected physical form factor is determined from among the one or more recommended physical form factors.

18. An apparatus of claim 11, wherein the apparatus is further caused to:
determine one or more available physical form factors for the at least one application based, at least in part, on the at least one user privacy policy.

19. An apparatus of claim 11, wherein the apparatus is further caused to:
receive a user input for specifying the at least one selected physical form factor; and
cause, at least in part, an application of the at least one user privacy policy at the at least one device based, at least in part, on the user input.

20. An apparatus of claim 11, wherein the at least interaction mode includes, at least in part, a data entry interaction by a user, wherein the apparatus is further caused to:
determine the at least one selected physical form factor based, at least in part, on the data entry interaction; and
cause, at least in part, an application of the at least one physical form factor at the at least one device for a duration of the data entry interaction.

21.-48. (canceled)
